(19) United States
(12) Patent Application Publication
(10) Pub. No.: US 2025/0013932 A1
(43) Pub. Date: Jan. 9, 2025

(54) TRAINING DATA GENERATION FOR MACHINE LEARNING OF A MODEL FOR PREDICTING A RISK OF OCCURRENCE OF A RARE EVENT

(71) Applicant: Commissariat à l'énergie atomique et aux énergies alternatives, Paris (FR)

(72) Inventor: Hakima BERDOUZ QRICHI ANIBA, Paris (FR)

(73) Assignee: Commissariat à l'énergie atomique et aux énergies alternatives, Paris (FR)

(21) Appl. No.: 18/760,084

(22) Filed: Jul. 1, 2024

(30) Foreign Application Priority Data
Jul. 5, 2023 (FR) 2307150

(51) Int. Cl. G06N 20/20

(52) U.S. Cl. CPC G06N 20/20

(57) ABSTRACT

The invention relates to a method and a device for generating training data for machine learning of a model for predicting a risk of occurrence of a rare event, said training data being formed by vectors of variables representative of a state of at least one monitored system before the occurrence of said rare event, from input training data (4) including a first initial set (6) of data associated with an absence of occurrence of said rare event, and a second initial set (8) of data associated with a presence of occurrence of said rare event. The device implements modules for determining (20), by an automatic learning method, at least one subset of variables associated with a risk of occurrence of said rare event higher than a risk threshold, generating (22) a third set of data by pseudo-random variations on said subset of data to provide an augmented database of training data.

This application claims priority to French Patent Application No. 2307150 filed Jul. 5, 2023, the entire disclosure of which is incorporated by reference herein.

### FIELD OF THE INVENTION

The invention relates to a method and a device for generating training data for machine learning of a model for predicting a risk of occurrence of a feared rare event.

The invention further relates to a method and a device for automatically training a model for predicting a risk of occurrence of an associated rare event.

Finally, the invention relates to associated computer programs.

The invention belongs to the general field of predicting the risk of occurrence of rare events, more particularly the early detection of precursor warning signals to rare events.

### BACKGROUND OF THE INVENTION

Recently, the use of artificial intelligence, in particular classification or prediction algorithms trained by machine learning, has allowed great advances to be made in the fields of diagnosis, fault prediction, whether for industrial systems, railway or early diagnostics serving to detect in patients the risks of developing various diseases.

However, such artificial intelligence algorithms are effective when same have been trained on so-called annotated or labeled training data, i.e. input data, containing variables having values characterizing the monitored data, taken over time if appropriate, which are associated with known classifications. When sufficient training data representative of each possible output class of a classification algorithm is provided in such a training phase, the parameters of the classification model implemented by the algorithm are calculated to ensure the performance of the algorithm.

Inherently, training data are present in bulk for common events, and are rare and unbalanced for rare events. In other words, the distribution of training data between data representative of current events and data representative of rare events is unbalanced.

Thereby, in a case of application to an industrial system, many operating data, e.g. taken by sensors, are available, which makes it possible to obtain many data prior to the occurrence of frequent breakdowns (wear and tear, etc.) and very little data prior to the occurrence of exceptional breakdowns.

Similarly, in the context of a diagnosis of a rare disease, the databases contain little data relating to patients carrying the disease compared to patients not carrying the disease.

In such cases, we speak of unbalanced training data, comprising a first set of data associated with an absence of occurrence of a feared rare event, and a second set of data associated with the presence of occurrence of said rare event, the cardinal of the first set being far superior to the cardinal of the second set, e.g. the cardinal of the first set being greater than 95% of the total cardinal of both sets, and the cardinal of the second set being lower than 5% of the total cardinal.

Thereby, the data of the second set are “embedded” in the set of training data, and the classification or prediction algorithm trained by machine learning on such training data is less efficient for predicting the rare event.

One of the goals of the invention is to remedy such drawbacks, in order to improve the performance of predicting the occurrence of rare events from initially unbalanced training data.

### SUMMARY OF THE INVENTION

To this end, the invention proposes, according to one aspect, a method of generating training data for machine learning of a model for predicting a risk of occurrence of a feared rare event, said training data being formed by vectors of variables representative of a state of at least one monitored system prior to the occurrence of said feared rare event, from input training data comprising a first initial set of data associated with an absence of occurrence of said rare event, and a second initial set of data associated with a presence of occurrence of said rare event. The method includes steps, implemented by at least one computation processor, of:
A) determination, from said first and second initial datasets, by a machine learning method, of at least one subset of variables associated with a risk of occurrence of said rare event higher than a risk threshold, said risk being calculated from the values of said variables,
B) generation of a third set of data by pseudo-random variations on that subset of data, and calculation of an associated risk,
C) grouping said first, second and third datasets into an augmented training data,
D) application of a first classification model by unsupervised learning based on augmented training data, resulting in at least three groups of training data, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold.

Advantageously, the method provides an increased database of training data, and thereby provides more balanced groups of training data. Advantageously, it is possible thereby to obtain a better prediction of the occurrence of rare events by applying the machine learning of a model or algorithm for predicting the feared rare event, when balanced training data are used.

The method of generating training data for machine learning of a model for predicting a risk of occurrence of a feared rare event according to the invention may also have one or a plurality of the following features, taken independently or in all technically feasible combinations:

The method further comprises:

E) applying at least one second machine learning classification model to reclassify at least the training data of the third group into the first group or into the second group, and estimating an associated reclassification error probability, the first training data group thus obtained forming a first output set of training data and the second training data group thus obtained forming a second output set of training data.

Step E) includes the application of a plurality of second classification models known as classifiers: application of a classifier by semi-supervised training on the training data of the first group and the training data of the third group, application of a supervised learning classifier to the training data of first group and to the training data of the second group and application of an unsupervised learning classifier to the training data of the second group and to the training data of the third group.

If the probability of reclassification error is higher than an error threshold, steps A) to D) are iterated, said first group of training data forming the first initial set of data and said second group of training data forming said second initial set of data for a subsequent iteration.

In step A) of determination, a method of automatic learning by random forests is applied.

According to another aspect, the invention relates to a device for generating training data for machine learning of a model for predicting a risk of occurrence of a feared rare event, said training data being formed by vectors of variables representative of a state of at least one monitored system prior to the occurrence of said feared rare event, from input training data including a first initial set of data associated with an absence of occurrence of said rare event, and a second initial set of data associated with a presence of occurrence of said rare event, the device including at least one computation processor configured to implement:
a determination module for determining, from said first and second initial sets of data, by a machine learning method, at least one subset of variables associated with a risk of occurrence of said rare event higher than a risk threshold, said risk being calculated from the values of said variables,
a generation module for generating a third set of data by pseudo-random variations on said subset of data, and calculating an associated risk,
a module for grouping said first, second and third datasets into an augmented training database,
an application module for applying a first classification model by unsupervised learning on the augmented training database, enabling at least three groups of training data to be obtained, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold.

The device for generating training data for machine learning of a model for predicting a risk of occurrence of a feared rare event further includes a module for applying at least one second classification model by machine learning to reclassify at least the training data of the third group in the a first group or in the second group, and an estimate of an associated reclassification error probability, wherein the first training data group thereby obtained forms a first output set of training data and the second training data group so obtained forms a second output set of training data.

The device for generating training data for machine learning of a model for predicting a risk of occurrence of a feared rare event is configured to implement the method for generating training data for machine learning of a model for predicting a risk of occurrence of a feared rare event, according to all embodiments thereof.

According to another aspect, the invention relates to a computer program including software instructions that, when implemented by a programmable electronic device, implement a method of generating training data for machine learning of a model for predicting a risk of occurrence of a feared rare event as briefly described hereinabove.

According to another aspect, the invention relates to a method of machine learning of a model for predicting a risk of occurrence of a feared rare event, implementing a method of generating training data as briefly described hereinabove and a step of learning the values of the prediction model implementing the training data obtained by the method.

According to another aspect, the invention relates to a device for automatically learning of an associated prediction model for predicting a risk of occurrence of a feared rare event, including a device for generating learning data for generating training data for machine learning of a model for predicting a risk of occurrence of a feared rare event as briefly described above and a module for learning the values of the prediction model implementing the training data obtained by said device for generating training data.

According to another aspect, the invention relates to a computer program including software instructions that, when implemented by a programmable electronic device, implement a method of machine learning of a model for predicting a risk of occurrence of a feared rare event as briefly described hereinabove.

### BRIEF DESCRIPTION OF THE DRAWINGS

Other features and advantages of the invention will emerge from the description given below, by way of indication and in no way limiting, with reference to the appended figures, among which:

FIG. 1 schematically represents a system comprising a device for generating training data for machine learning of a model for predicting a risk of occurrence of a feared rare event;

FIG. 2 is a synoptic diagram of the main steps of a method for generating training data according to a first embodiment;

FIG. 3 is a synoptic diagram of the main steps of a method for generating training data according to a second embodiment;

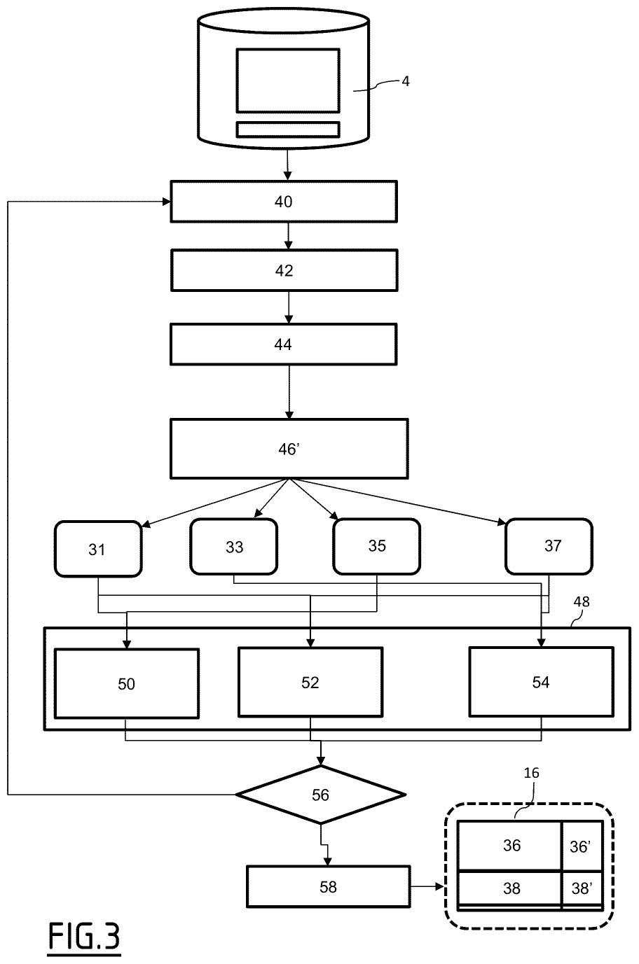

FIG. 4 is a synoptic diagram of the main steps of a machine learning process of a model for predicting a risk of occurrence of a feared rare event and for implementing said prediction model.

### DETAILED DESCRIPTION OF EMBODIMENTS

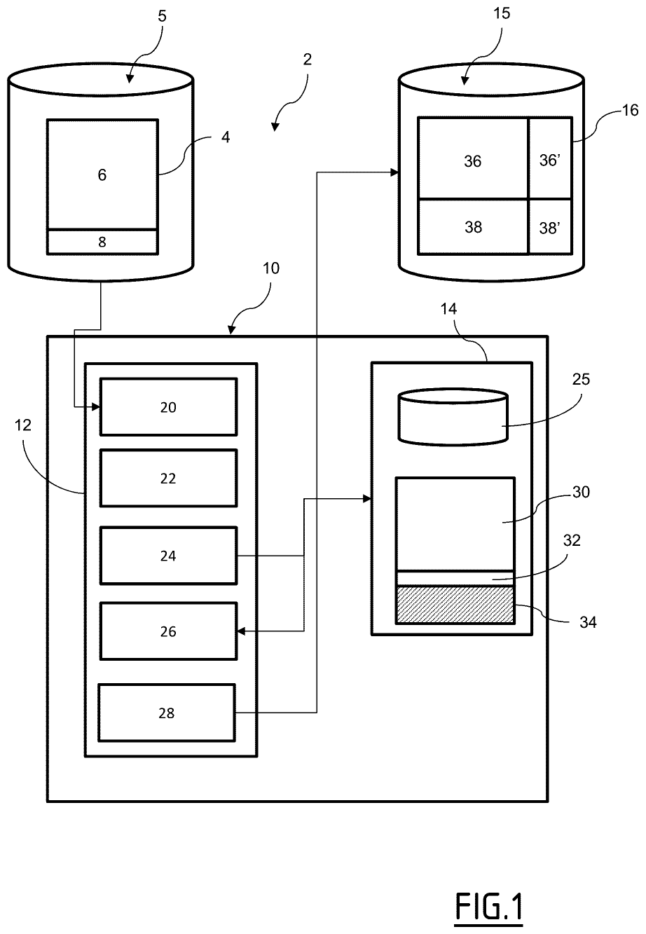

FIG. 1 schematically illustrates a system 2 for generating training data for machine learning of a model for predicting a risk of occurrence of a feared rare event.

System 2 is presented generically. There are many applications of such a system, e.g. for predicting the risk of exceptional malfunction of a monitored industrial system or for diagnosing the risk of a patient suffering from a rare disease.

In general, a monitored system is called a system in which the feared rare event is likely to occur.

For example, in the industrial application, a monitored system is a type of plant or a set of equipment to be monitored.

In the diagnostic application, the monitored system is the organism of a patient, based on recorded data.

For predicting the risk of a rare event, a prediction model is used, which is trained by machine learning on training data (or input data) representative of characteristics of monitored systems of the same type.

In other words, for the industrial application, e.g. if the monitored system is a coal-fired electricity power plant, the training data is data representative of one, or preferably a plurality of coal-fired electricity power plants, taken over time. In addition, characteristics such as the type and the age of the equipment used are also provided.

For example, for the diagnostic application, patient data, e.g. results of in vitro analysis tests, and patient characteristics (e.g. age, sex) are stored.

It is clear that the training data are data suitable for the intended application.

Preferably, such data are organized in the form of variable vectors having values representative of a monitoring data state of the monitored system. In other words, each vector is associated with a state of a monitored system.

Of course, a plurality of vectors may be associated with the same monitored system.

The values of the variables are e.g. provided by sensors and recorded over time (e.g. alarm feedback, reading of operating measurements, deviation or anomaly, technical fact).

The training data are recorded before the occurrence of a feared rare event, but for at least part of the training data, the occurrence of the rare event has been noted (i.e. feared malfunction or reported rare disease).

The training data are gathered in an input training database 4, stored in a data storage system 5.

The database 4 includes a first initial set 6 of data associated with an absence of occurrence of said rare event. A probability of occurrence of the rare event is also memorized, the probability of occurrence coming from an a priori knowledge, e.g. either from the opinion of an expert in the field in the case of supervised learning, or from the results resulting from the prior implementation of unsupervised machine learning algorithms, such as Association or Clustering, which serve to associate or combine in the same class, events with the same probability of occurrence and/or with the same level of risk.

The database 4 includes a second initial set 8 of data associated with a presence of occurrence of said rare event, i.e. same are data taken from monitored systems for which the feared rare event occurred.

The first initial set 6 has a cardinal N1 (i.e. includes N1 variable vectors), the second initial set 8 has a cardinal N2 (i.e. includes N2 variable vectors).

In the database 4, the number N1 is substantially higher than N2, i.e. N2<X/100×(N1+N2), where X is e.g. lower than 10, or even lower than 5, and even lower than 1.

One of the goals of the training data generation system 2 is to provide better balanced training datasets, in order to better characterize the risk of occurrence of the feared rare event.

The training data generation system 2 includes a device 10 for generating training data, which is e.g. a programmable electronic device or a plurality of interconnected programmable electronic devices.

The device 10 includes in particular a calculation unit 12, including one or a plurality calculation processors, and an electronic memory 14, adapted for communicating via a data communication bus (not shown).

The device 10 is also adapted for communicating, in read and write mode, with the data storage system 5, which comprises the input training database 4.

Similarly, the device 10 is also adapted for communicating, in read and write mode, with a data storage system 15 configured to store an output training database 16, described in greater detail thereafter.

Each of the data storage systems 5, 15 is a computer-readable medium and is e.g. a medium apt to store the electronic instructions and to be coupled to a bus of a computer system. As an example, the readable medium is an optical disk, a magneto-optical disk, a ROM, a RAM, any type of non-volatile memory (e.g. EPROM, EEPROM, FLASH, NVRAM), a magnetic card or an optical card.

The device 10 comprises the following modules, implemented by the calculation unit 10:
a module 20 for determining, from the first and second initial datasets 6, 8, by a machine learning method, at least one subset of variables associated with a risk of occurrence of the rare event higher than a risk threshold, said risk being calculated from values of said variables;
a module 22 for generating a third set of data by pseudo-random variations on said subset of data, and calculation of an associated risk;
a module 24 for grouping the first, second and third datasets into an augmented training database 25;
a module 26 for the application of a first classification model by unsupervised learning on the augmented training database, serving to obtain:
   a first group of training data 30 associated with a risk of occurrence of the rare event lower than a first threshold S1;
   a second group of training data 32 associated with a risk of occurrence of the rare event higher than a second threshold S2;
   a third group of training data 34 associated with a third risk, lower than the second threshold S2 and higher than the first threshold S1;
a module 28 for applying at least one second classification model by machine learning to reclassify at least the training data of the third group 34 into the first group or into the second group, and estimation of an associated reclassification error probability.

In one embodiment, the module 28 implements three distinct second classification models (also called classifiers), comprising an unsupervised classifier, a semi-supervised classifier and an unsupervised classifier.

It is planned to execute modules 20, 22, 24, 26 and 28 iteratively, until the probability of reclassification error is considered satisfactory, i.e. lower than a predetermined error threshold.

At the output, a training database 16 is obtained including at least a first output set of training data 36 and a second output set of training data 38, obtained after application of the module 28, each output set 36, 38 having a risk of occurrence of the associated feared rare event, 36′, 38′. For example, the risk of occurrence 36′ of the feared rare event, associated with the first output set 36, is low, e.g. lower than a first risk threshold, e.g. lower than 15% or lower than 5% probability of occurrence, and the risk of occurrence 38′ of the feared rare event, associated with the second output set 38, is high, e.g. higher than 55% or 65% probability of occurrence.

Advantageously, the cardinal N′1 of the first output set of training data 36 is lower than the cardinal N1 of the first initial set 6, and the cardinal N′2 of the second output set of training data 38 is greater than the cardinal N2 of the first initial set 8. In other words, a rebalancing of the training data is performed, and an associated risk is also calculated. To the extent that the training data is associated with a risk of occurrence of the feared rare event, the re-balanced training database also includes information on the risk. It is also said that the training data obtained is “informed” of the risk of occurrence of the feared rare event.

In a variant, more than two output sets are obtained, each of the output sets having a risk of occurrence of the associated feared rare event.

In one embodiment, the modules 20, 22, 24, 26 and 28 are implemented as software code, and form a computer program, including software instructions that, when implemented by a programmable electronic device, implement a method of generating training data for machine learning of a model for predicting a risk of occurrence of a feared rare event.

In a variant (not shown), the modules 20, 22, 24, 26 and 28 are each implemented in the form of a programmable logic component, such as an FPGA (Field Programmable Gate Array), or a GPGPU (General-purpose Graphics Processing Unit), or else in the form of a dedicated integrated circuit, such as an ASIC (Application Specific Integrated Circuit).

The computer program for generating training data is furthermore apt to be recorded on a computer-readable medium (not shown). The computer readable medium is e.g. a medium apt to store electronic instructions and to be coupled to a bus of a computer system. As an example, the readable medium is an optical disk, a magneto-optical disk, a ROM, a RAM, any type of non-volatile memory (e.g. EPROM, EEPROM, FLASH, NVRAM), a magnetic board or an optical board.

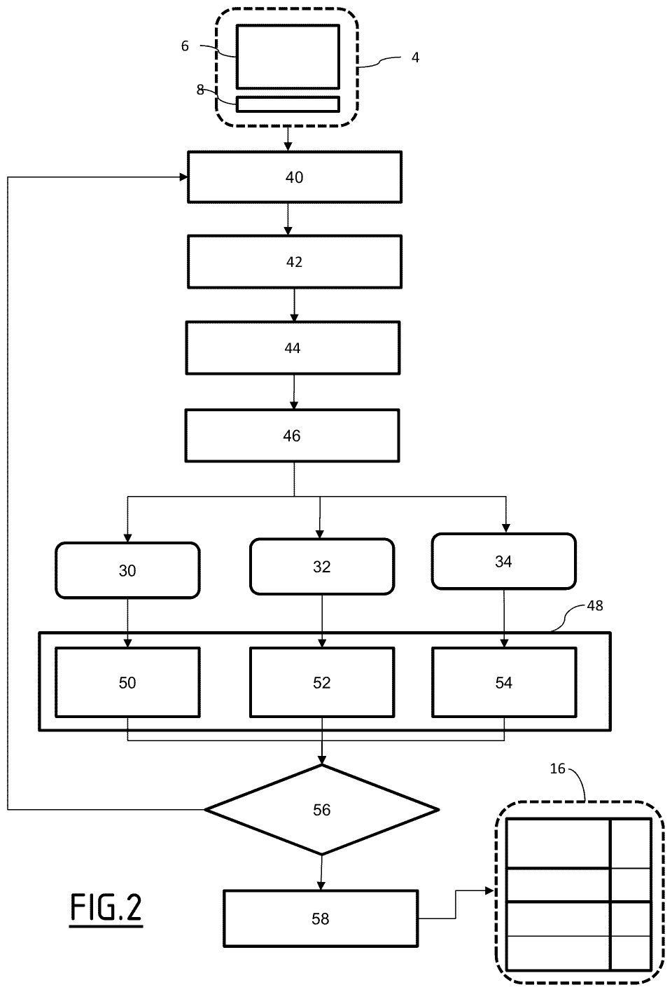

FIG. 2 is a synoptic diagram of the main steps of a method of generating training data, in a first embodiment, for a monitored system and a feared rare event.

The input training database 4 is provided, comprising the first initial set of training data corresponding to the absence of occurrence of the rare event, and the second initial set of data corresponds to the occurrence of the rare event.

Each set comprises the same types of data, including vectors of variables representative of states of one or a plurality monitored systems of the same type.

The method comprises a first step 40, implemented by the module 20, of determining from said first and second initial datasets, by a machine learning method, at least one subset of variables associated with a risk of occurrence of said rare event higher than a risk threshold, said risk being calculated from values of said variables.

In other words, step 40 performs artificial intelligence-assisted modeling of risk exposure.

For example, the machine learning method implemented in step 40 is a random forest learning method with bootstrap, a well-known technique of random sampling with replacement. Advantageously, it is thereby possible to generate a distribution of estimates instead of a single point estimate, and to obtain uncertainty values from the associated estimates. In a variant, the XGBoost algorithm (for “extreme Gradient Boosting”) is implemented.

According to other variants, in step 40, a logistic regression or a support vector machine (SVM) is implemented.

Step 40 serves to determine states of the monitored system that are precursors of the feared rare event.

Such states are characterized by variables having given values.

A risk of occurrence of the associated feared rare event is calculated by a chosen formula.

For example, the risk is calculated as follows:

Risk_{Informed}Variable=Occ*Variable²*A

With Variable referring to the variable of interest associated with a given risk (e.g. an oncogene expression or a Health biomarker) or an impact variable (e.g. severity of a consequence induced by an anomaly in an industrial environment);

Occ referring to the occurrence or frequency of occurrence of said risk, associated with said variable;

A referring to the function of mitigating or amplifying the risk depending on the overall state of the system in industrial application or the overall state of health of a patient (co-morbidities, environmental and/or occupational exposures at risk, etc.).

In one embodiment, A is a multiplicative factor.

In an example conducted on clinical and genetic data for predicting patients at high risk of developing aggressive clear cell kidney cancer, we first performed a logarithmic normalization of gene expressions to re-balance the weight of each gene with other available clinical data to ensure a balanced consideration and a standardized predictive approach to Machine Learning classification algorithms.

In the present example, we introduced and generated for each initial normalized data (data), a new associated data (data_risk) which is defined as a function modeling the risk borne by the initial data, according to the following formula:

$${data}_{risk} = Occurrence * {data}^{2} * A$$

A predetermined risk threshold is used, depending on the field of application, e.g. a risk threshold between 5% and 15% of a predetermined risk level, e.g. maximum, depending on the recommendations and feedback from the field of application.

The method then comprises a step 42 of generating a third set of data by pseudo-random variations on the subset of data obtained in step 40, and calculating an associated risk.

It is thereby possible to artificially generate data corresponding to monitored system states precursors of the feared rare event.

In one embodiment, step 42 implements a clustering algorithm, e.g. the K-class clustering algorithm known as K-means for adapting the introduction of pseudo-random variations. Step 42 serves to find hidden correlations between the different events that are not annotated (or not labeled) by grouping same into equivalent risk classes.

The first, second initial sets and the third set of data generated in step 42 are grouped in step 44 into an augmented database.

The method then comprises a step 46 of applying a first classification model by unsupervised machine learning on the augmented database of training data, serving to obtain three previously defined groups of training data 30, 32, 34, which are respectively:
a first group of training data 30 associated with a risk of occurrence of the rare event being lower than a first threshold S1;
a second group of training data 32 associated with a risk of occurrence of the rare event higher than a second threshold S2, the threshold S2 being higher than S1;
a third group of training data 34 associated with a third risk, lower than the second threshold S2 and higher than the first threshold S1.

For example, threshold S1 is comprised between 5% and 10% probability of occurrence, threshold S2 is comprised between 15% and 25% probability of occurrence.

Unlike supervised learning, unsupervised learning allows the algorithm to learn and predict with unannotated (or unlabeled) examples independently. Unsupervised learning algorithms are used in particular to classify data, calculate distribution density and associated uncertainties thereof, and to reduce dimensions in the case of a large number of variables, much larger than the number of individuals (example in Health, 20,000 genes for a few hundred cancer patients).

For example, step 46 implements a “clustering” or “association” method, such type of methods being reference methods in the field of unsupervised machine learning. Other methods can also be applied, e.g. principal component analysis (PCA).

Step 46 is followed by a step 48 of applying at least one second classification model (or classifier) by machine learning to reclassify the training data and calculate an associated reclassification error probability.

Classification errors are associated with uncertainties associated with data, data collection and processing systems, and also with models and algorithms. In the prior art, several methods make it possible to address this point by deploying the so-called re-sampling strategy.

Distinction is thereby made between Oversampling and Undersampling.

Oversampling methods work by increasing the number of observations of the minority class(s) in order to achieve a satisfactory minority class/majority class ratio.

Undersampling methods work by reducing the number of observations of the majority classes until a balanced ratio is reached.

There are several Machine Learning algorithms for generating synthetic samples automatically. The most popular of the algorithms is SMOTE (for Synthetic Minority Over-sampling Technique). SMOTE is an Oversampling method that works by creating synthetic samples from the minority class instead of creating simple copies.

The ClusterCentroids algorithm is an Undersampling algorithm based on clustering methods to generate a certain number of centroids from the original data, without loss of information about the majority class during the reduction thereof.

In such embodiment, step 48 includes a substantially parallel implementation of three distinct classifiers in sub-steps 50, 52, 54.

For example, substep 50 implements a semi-supervised machine learning classifier on the training data of the first group and the training data of the third group. Semi-supervised learning allows a model to be trained on a partially annotated dataset that has some annotated data and a majority of unannotated data. The idea is to assign annotations using the similarity between a small number of annotated data and a larger volume of unannotated data. For example, the substep 50 implements a Generative Adversial Networks (GAN) model.

For example, the substep 52 implements a classifier by supervised machine learning, e.g. a Support Vector Machine (SVM) or a logistic regression, on the training data of the first group and the training data of the second group.

For example, substep 54 implements an unsupervised machine learning classifier, e.g. a Clustering or Association algorithm, on the training data of the second group and the training data of the third group.

Advantageously, the respective classifiers are implemented independently, which makes it possible to evaluate and quantify the impact of uncertainties in order to reduce same.

The method then includes a step 56 of comparing the minimum of the reclassification error probability, among the three sets, with a predetermined error threshold SP (or reclassification error probability threshold). If the minimum of the reclassification error probability is higher than the error threshold SP, steps 40 to 48 are iterated.

Otherwise, the method comprises a step 58 of obtaining at least two output sets 36, 38 of training data and of calculating the risk of occurrence of the associated rare event.

In a second embodiment of the method for generating training data for machine learning of a model for predicting a risk of occurrence of a feared rare event, the method includes steps 40 to 44 analogous to the steps described hereinabove.

In a different way from the first embodiment, the method includes a step 46′ of applying a first classification model by unsupervised machine learning on the basis of data augmented by training data, making it possible to obtain a number G greater than 3 of groups of training data, e.g. a number G=4. Each data group is associated with a probability of risk of occurrence of the rare event within a range of values, e.g.:
A first group of training data 31 associated with a risk of occurrence of the rare event comprised between 0% and 25% probability of occurrence of the rare event;
A second group of training data 33 associated with a risk of occurrence of the rare event comprised between 25% and 50% probability of occurrence of the rare event;
A third group of training data 35 associated with a risk of occurrence of the rare event comprised between 50% and 75% probability of occurrence of the rare event;
A fourth group of training data 37 associated with a risk of occurrence of the rare event comprised between 75% and 100% probability of occurrence of the rare event.

It is understood that the above can be generalized to any number G of learning groups.

The method in the second embodiment then includes a step 48′, analogous to step 48 described hereinabove, of applying at least one second classification model (or classifier) by machine learning to reclassify the training data, and calculate an associated reclassification error probability.

In such embodiment, a plurality of groups of training data are provided as inputs to the first, second and third classifiers 50, 52, 54.

Various groupings of the groups of training data supplied to the input of the first, second and third classifiers can be envisaged, the input groupings being performed e.g. as a function of the number of unbalanced data.

For example, in the embodiment illustrated, the training data of the first group 31 and of the third group 35 are supplied as input to the first classifier, the training data of the first group 31 and of the fourth group 37 are supplied as input to the second classifier, the training data of the second group 33 and of the fourth group 37 are supplied as input to the third classifier.

In a variant, other groupings are envisaged, depending on the application and/or the respective cardinals of the training data groups.

The following steps 56, 58 are analogous to the steps previously described with reference to FIG. 2.

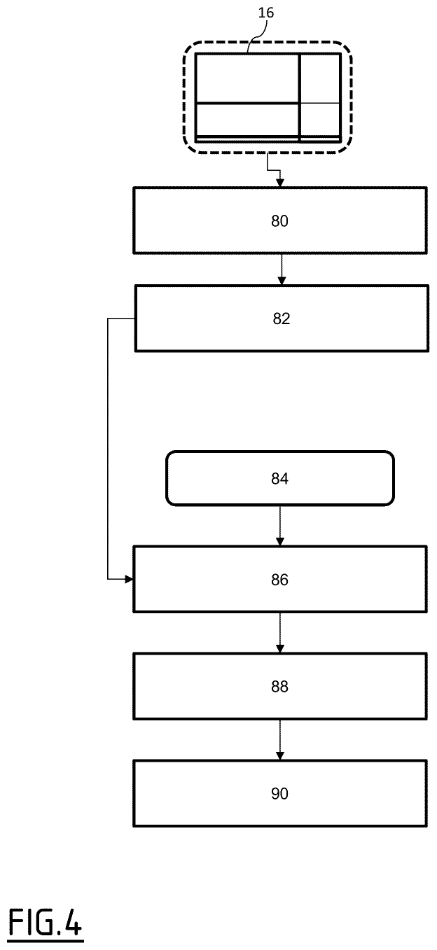

FIG. 4 illustrates a method of using the generated training data.

The present method includes a machine learning phase of the prediction model and a subsequent use phase for the effective prediction of the risk of occurrence of a rare event in a monitored system, e.g. an industrial monitored system.

The method includes, in the learning phase, a reception of the training database 16 including the at least two output sets 36, 38 of training data generated by the method of generating training data described hereinabove. The training data are of course data representative of characteristics of monitored systems of a given type, which have been balanced by the method described hereinabove.

The method includes at step 80 of machine learning of a model for predicting the risk of occurrence of a given feared rare event on the balanced training data.

The method also comprises a storage 82 of the prediction model, i.e. of its architecture and the parameter values characterizing it.

The method comprises, in a second phase of actual use, the supply of input data 84 characteristic of a monitored system, for which the risk of occurrence of the rare event is not known a priori.

The method then comprises a step 86 of implementing the prediction model stored in step 82, on the input data 84, and obtaining an effective risk R of occurrence of the associated rare event.

If the actual risk is higher than a predetermined critical risk threshold (step 88), the method comprises the implementation 90 of a preventive action: e.g., in the case of a monitored industrial system, sending an alert, with associated information where appropriate, making it possible to determine preventive actions: predictive maintenance, targeted equipment shutdown etc.

The critical risk threshold is defined depending on the application.

The method of using the training data is implemented by one or a plurality of programmable electronic devices.

For example, the method is implemented by a programmable electronic device physically analogous to the device 10 for generating training data, which further includes a module for learning the values of the prediction model implementing the obtained training data, and/or a module for implementing the stored prediction model, and a module for applying a preventive action following the determination of an actual risk higher than a critical risk threshold.

Advantageously, the invention thereby proposes an automated device and method for balancing unbalanced data by generating new “Risk-informed” data, i.e. data stored in association with an associated risk value, for machine learning of a model or algorithm for predicting exposure to a feared rare event.

Advantageously, the inventors have shown that the performance score characterizing the performance of prediction algorithms (or models) trained by machine learning, e.g. the F1-score, which evaluates the ability of a classification model to effectively predict positive individuals by making a trade-off between accuracy and recall is systematically improved when the balanced training database is used.

1. A method for generating training data for machine learning of a model for predicting a risk of occurrence of a feared rare event, said training data being formed by vectors of variables representative of a state of at least one system monitored before the occurrence of said feared rare event,
from input training data including a first initial set of data associated with an absence of occurrence of said rare event, and a second initial set of data associated with a presence of occurrence of said rare event, the method including steps, implemented by at least one computer processor, of:
A) determination, from said first and second initial datasets, by a machine learning method, of at least one subset of variables associated with a risk of occurrence of said rare event higher than a risk threshold, said risk being calculated from the values of said variables,
B) generation of a third set of data by pseudo-random variations on said subset of data, and calculation of an associated risk,
C) grouping said first, second and third datasets into an augmented training database,
D) application of a first classification model by unsupervised learning based on augmented training data, resulting in at least three groups of training data, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold.

2. The method according claim 1, further including
E) an application of at least one second machine learning classification model to reclassify at least the training data of the third group into the first group or into the second group, and estimation of an associated reclassification error probability, the first group of training data thereby obtained forming a first output set of training data and the second group of training data thereby obtained forming a second output set of training data.

3. The method according to claim 2, wherein step E) includes the application of a plurality of second classifier models: application of a semi-supervised learning classifier to the training data of the first group and the training data of the third group, application of a supervised learning classifier to the training data of the first group and the training data of the second group and application of an unsupervised learning classifier to the training data of the second group and the training data of the third group.

4. The method according to claim 2, wherein if said reclassification error probability is higher than an error threshold, steps A) to D) are iterated, said first group of training data forming the first initial set of data and said second group of training data forming said second initial set of data for a subsequent iteration.

5. The method according to claim 1, in which a random forest machine learning method is applied in the determining step A).

6. A method of machine learning of a model for predicting a risk of occurrence of a feared rare event, implementing generating training data for machine learning of a model for predicting a risk of occurrence of a feared rare event, said training data being formed by vectors of variables representative of a state of at least one system monitored before the occurrence of said feared rare event,
from input training data including a first initial set of data associated with an absence of occurrence of said rare event, and a second initial set of data associated with a presence of occurrence of said rare event, the method including steps, implemented by at least one computer processor, of:
A) determination, from said first and second initial datasets, by a machine learning method, of at least one subset of variables associated with a risk of occurrence of said rare event higher than a risk threshold, said risk being calculated from the values of said variables,
B) generation of a third set of data by pseudo-random variations on said subset of data, and calculation of an associated risk,
C) grouping said first, second and third datasets into an augmented training database,
D) application of a first classification model by unsupervised learning based on augmented training data, resulting in at least three groups of training data, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold.
and further comprising learning the values of the prediction model using the training data obtained by the method of generating training data.

7. A computer program including software instructions which, when executed by a programmable device, implement a method of generating training data according to claim 1.

8. A computer program including software instructions which, when executed by a programmable device, implement a machine learning method according to claim 6.

9. A device for generating training data for machine learning of a model for predicting a risk of occurrence of a feared rare event, said training data being formed by vectors of variables representative of a state of at least one system monitored before the occurrence of said feared rare event, from input training data including a first initial set of data associated with an absence of occurrence of said rare event, and a second initial set of data associated with an occurrence of said rare event, the device including at least one calculation processor configured to implement:
a module for determining, from said first and second initial sets of data, by a machine learning method, at least one subset of variables associated with a risk of occurrence of said rare event higher than a risk threshold, said risk being calculated from the values of said variables,
a module for generating a third set of data by pseudo-random variations on said subset of data, and calculation of an associated risk,
a module for grouping said first, second and third datasets into an augmented training database,
a module for applying a first classification model by unsupervised learning on the augmented training database, serving to obtain at least three groups of training data, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold.

10. A device for generating training data for the machine learning of the model for predicting a risk of occurrence of a feared rare event according to claim 9, further comprising a module for applying at least one second machine learning classification model to reclassify at least the training data of the third group into the first group or into the second group, and estimating an associated reclassification error probability, the first training data group thus obtained forming a first output set of training data and the second training data group thus obtained forming a second output set of training data.

11. A device for automatic learning of a model for predicting a risk of occurrence of a feared rare event, including a device for generating learning data for machine learning of a model for predicting a risk of occurrence of a feared rare event, said training data being formed by vectors of variables representative of a state of at least one system monitored before the occurrence of said feared rare event, from input training data including a first initial set of data associated with an absence of occurrence of said rare event, and a second initial set of data associated with an occurrence of said rare event, the device including at least one calculation processor configured to implement:
a module for determining, from said first and second initial sets of data, by a machine learning method, at least one subset of variables associated with a risk of occurrence of said rare event higher than a risk threshold, said risk being calculated from the values of said variables,
a module for generating a third set of data by pseudo-random variations on said subset of data, and calculation of an associated risk,
a module for grouping said first, second and third datasets into an augmented training database,
a module for applying a first classification model by unsupervised learning on the augmented training database, serving to obtain at least three groups of training data, comprising a first group of training data associated with a risk of occurrence of said rare event lower than a first threshold; a second group of training data associated with a risk of occurrence of said rare event higher than a second threshold; a third group of training data associated with a third risk, lower than the second threshold and higher than the first threshold
and further comprising a module for learning the values of the prediction model implementing the training data obtained by said device for generating training data.
